(19) United States
(12) Patent Application Publication
(10) Pub. No.: US 2025/0346455 A1
(43) Pub. Date: Nov. 13, 2025

(54) ELEVATOR SHEAVE LINER, ELEVATOR SHEAVE ASSEMBLY, AND ELEVATOR SYSTEM

(71) Applicant: Otis Elevator Company, Farmington, CT (US)

(72) Inventors: Yanchao Niu, Tianjin (CN); Ruguang Liu, Tianjin (CN)

(21) Appl. No.: 19/194,813

(22) Filed: Apr. 30, 2025

(30) Foreign Application Priority Data
May 9, 2024 (CN) 202410568124.3

(51) Int. Cl. B66B 15/04

(52) U.S. Cl. CPC B66B 15/04

(57) ABSTRACT

An elevator sheave liner, an elevator sheave assembly, and an elevator system are disclosed. The elevator sheave liner includes two or more combinable segments arranged in a combinable manner on an elevator sheave to form an elevator sheave liner for engagement with an elevator tension member, at least one of the combinable segments is provided with a first concave-convex structure along a transverse direction on a bottom of the at least one of the combinable segments, the first concave-convex structure matching a second concave-convex structure arranged transversely on an outer circumferential surface of the elevator sheave to engage correspondingly with each other when the at least one combinable segment is arranged on the elevator sheave.

### FOREIGN PRIORITY

This application claims priority to Chinese Patent Application No. 202410568124.3, filed May 9, 2024, and all the benefits accruing therefrom under 35 U.S.C. § 119, the contents of which in its entirety are herein incorporated by reference.

### TECHNICAL FIELD OF INVENTION

The present disclosure relates to the technical field of elevators, in particular to an elevator sheave liner, an elevator sheave assembly, and an elevator system.

### BACKGROUND OF THE INVENTION

In elevator systems, power devices such as traction machines and winches are usually configured to provide power for system operation. When the elevator sheave (such as the traction sheave) is driven by power to rotate, it will transfer power to the elevator tension member installed on the elevator sheave, causing the latter to start moving, thereby driving the elevator car and/or counterweight connected to the elevator tension member to move along the elevator shaft. Usually, a liner is configured on the elevator sheave to increase friction, reduce wear between components, and prolong the lifespan of components. The present application has found, after research, that the elevator sheave liner in the prior art still needs to be improved in terms of structure, performance, installation, replacement and maintenance operations, manufacturing costs, and other aspects.

### SUMMARY OF THE INVENTION

In view of the foregoing, the present disclosure provides an elevator sheave liner, an elevator sheave assembly, and an elevator system, so as to solve or at least alleviate one or more of the aforementioned problems and other problems in the prior art, or to provide alternative technical solutions for the prior art.

Firstly, according to one aspect of the present disclosure, an elevator sheave liner is provided, the elevator sheave liner comprising two or more combinable segments arranged on an elevator sheave in a combinable manner to form an elevator sheave liner for engagement with an elevator tension member, wherein at least one of the combinable segments is provided with a first concave-convex structure along a transverse direction on a bottom of the at least one of the combinable segments, the first concave-convex structure matching a second concave-convex structure arranged transversely on an outer circumferential surface of the elevator sheave to engage correspondingly with each other when the at least one combinable segment is arranged on the elevator sheave.

In an elevator sheave liner according to the present disclosure, optionally, the combinable segment has a first end and a second end opposite to each other along a circumferential direction of the elevator sheave, the first concave-convex structure is arranged at a position between the first end and the second end, and/or a portion of the first concave-convex structure is arranged at the first end or the second end, and the other portion of the first concave-convex structure is arranged at a corresponding end of another combinable segment adjacent to the combinable segment.

In an elevator sheave liner according to the present disclosure, optionally, the first concave-convex structure comprises at least one groove arranged along an axial direction of the elevator sheave, and the second concave-convex structure comprises at least one convex portion arranged along the axial direction of the elevator sheave.

In an elevator sheave liner according to the present disclosure, optionally, the combinable segment is configured with: a first side end and a second side end opposite to each other along the axial direction of the elevator sheave, wherein the first side end is configured to be mounted in place against a first assembly portion on the elevator sheave during installation, and the second side end is configured to be engaged with a second assembly portion on the elevator sheave during installation; and a convex portion arranged between the first side end and the second side end and configured for installation in a groove arranged along the circumferential direction on the elevator sheave.

In an elevator sheave liner according to the present disclosure, optionally, the second assembly portion is provided at an outer end of the elevator sheave, and the second side end is configured to extend outwardly along a radial direction of the elevator sheave and exceed the groove after installation, for disassembling the combinable segment from the elevator sheave by applying a force to the second side end to cause the combinable segment to disengage from the groove.

In an elevator sheave liner according to the present disclosure, optionally, a seam between two adjacent combinable segments of the elevator sheave liner is configured in a shape of a step, an arc, or an oblique line forming an angle of less than 90° and not less than 10° with a longitudinal section of the elevator sheave.

In an elevator sheave liner according to the present disclosure, optionally, an assembly portion is provided on the combinable segment for securing the elevator sheave liner formed after combination in place on the elevator sheave by installing a fastening member in the assembly portion and providing a force along the radial direction of the elevator sheave.

Secondly, the present disclosure also provides an elevator sheave assembly, which comprises: an elevator sheave liner according to any of the above; and an elevator sheave having a second concave-convex structure arranged on an outer circumferential surface thereof, wherein the second concave-convex structure is engaged correspondingly with the first concave-convex structure of the elevator sheave liner when the elevator sheave liner is arranged on the elevator sheave.

In an elevator sheave assembly according to the present disclosure, optionally, the elevator sheave comprises a body, and a bracket detachably arranged on the body and engaged with the elevator sheave liner.

In an elevator sheave assembly according to the present disclosure, optionally, the bracket has two or more assemblable bracket segments arranged on the body in a combinable manner.

In an elevator sheave assembly according to the present disclosure, optionally, each assemblable bracket segment has a first portion and a second portion, the first portion is provided with a groove for engagement with a convex portion on the combinable segment, and the second portion is connected to the first portion and extends along a radial direction of the elevator sheave towards a center direction of the elevator sheave.

In an elevator sheave assembly according to the present disclosure, optionally, the number of the assemblable bracket segments configured is the same as the number of the combinable segments configured, and each pair of assemblable bracket segment and combinable segment, after being separately arranged in a combinable manner, are secured to the body through a mounting member.

In an elevator sheave assembly according to the present disclosure, optionally, the elevator sheave liner is further connected to the elevator sheave through an adhesive.

In addition, according to another aspect of the present disclosure, an elevator system is further provided, which comprises: a power device, configured to provide power; an elevator car configured to run between elevator landings when driven by the power; and an elevator tension member, and an elevator sheave assembly according to any of the above, wherein the elevator sheave is connected to a power output end of the power device, and the elevator tension member is engaged with the elevator sheave liner and connected to the elevator car to transmit the power to the elevator car.

In an elevator system according to the present disclosure, optionally, the power device includes a traction machine and a winch, and/or the elevator tension member includes a steel belt and a rope.

The elevator sheave liner according to the present disclosure has the advantages of simple structure, stable working performance, high reliability, and convenient installation, replacement and maintenance operations. The elevator sheave liner can firmly engage the elevator sheave and is not easy to slip, loosen or fall off. In addition, even in the unfavorable situation where the elevator sheave liner is completely worn out, a reusable bracket structure can be used to meet the traction force requirements of the elevator, which not only significantly improves system safety, but also helps to prolong the service life of elevator tension members and other members, reduce system downtime and lower overall costs.

### BRIEF DESCRIPTION OF THE DRAWINGS

The technical solutions of the present disclosure will be described in further detail below with reference to the accompanying drawings and embodiments. However, it should be understood that these drawings are designed merely for the purpose of explanation and only intended to conceptually illustrate the structures and configurations described herein, and are not required to be drawn to scale.

FIG. 1 is a three-dimensional structural schematic diagram of an example of an elevator system that can adopt various embodiments of the present disclosure.

FIG. 2 is a three-dimensional structural schematic diagram in which a combinable segment in an embodiment of an elevator sheave liner according to the present disclosure is matched and engaged with an assemblable bracket segment in an embodiment of an elevator sheave.

FIG. 3 is a side-view structural schematic diagram of a pair of matched and engaged combinable segment and assemblable bracket segment shown in FIG. 2.

FIG. 4 is an enlarged front-view structural schematic diagram of Part A in FIG. 2.

FIG. 5 is a local segmental three-dimensional structural schematic diagram in which an embodiment of an elevator sheave liner and an embodiment of an elevator tension member according to the present disclosure are arranged on an embodiment of an elevator sheave.

FIG. 6 is a three-dimensional structural schematic diagram in which an embodiment of an elevator sheave liner and an embodiment of an elevator tension member according to the present disclosure are arranged on an embodiment of an elevator sheave.

FIGS. 7(a)-7(d) shows a local top-view structural schematic diagram in which four different embodiments of an elevator sheave liner according to the present disclosure are respectively installed on an embodiment of an elevator sheave.

### DETAILED DESCRIPTION OF THE INVENTION

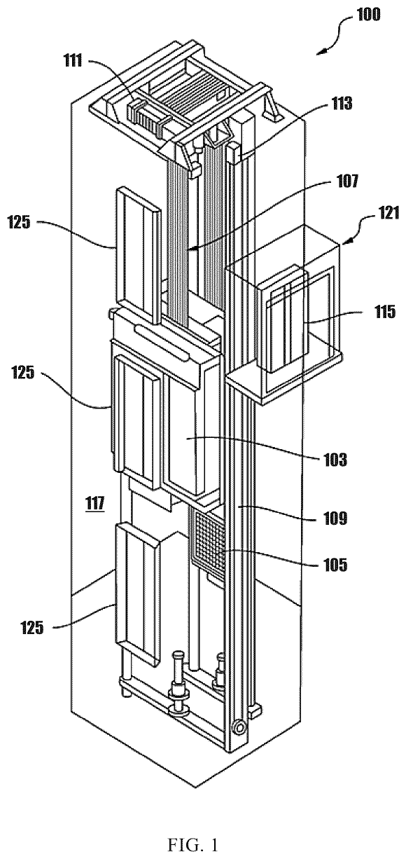

FIG. 1 is a perspective view of an elevator system 100 including an elevator car 103, a counterweight 105, a tension member 107, a guide rail (or rail system) 109, a machine (or machine system) 111, a position reference system 113, and an electronic elevator controller (controller) 115. The elevator car 103 and counterweight 105 are connected to each other by the tension member 107. The tension member 107 may include or be configured as, for example, steel belts (such as coated-steel belts) and/or ropes (such as steel cables). The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 100. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown in FIG. 1, in a controller room 121 of the elevator shaft 117 and is configured to control the operation of the elevator system 100, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. At this point, the passengers can get in or out of the elevator car 103 through the opened elevator landing door. Although shown in a controller room 121, those of skill in the art will appreciate that the controller 115 can be located and/or configured in other locations or positions within the elevator system 100. In one embodiment, the controller may be located remotely or in the cloud.

The machine 111 may include a motor or similar driving mechanism to provide operating power to elevator system 100, and such elevator driving devices are often referred to as traction machines, winches, etc. in practical applications. In accordance with embodiments of the present disclosure, the machine 111 can be configured to include an electrically driven motor. The power supply for the motor may be any power source, including a power grid, which, in combination with other components, is supplied to the motor. The machine 111 may include an elevator sheave 20, which may be used as, for example, a traction sheave that imparts force to tension member 107 to move the elevator car 103 within elevator shaft 117 to reach the desired elevator landing 125.

Although specific elevators and components are shown and described herein, FIG. 1 is merely a non-limiting example presented for illustrative and explanatory purposes. It should be noted that other elevator systems can be configured to use the elevator sheave liner and elevator sheave assembly disclosed herein. Additionally, for the sake of simplification, identical or similar components and features may only be indicated in one or several locations within the same drawing. Technical terms such as “first” and “second” are only used for the purpose of distinguishing and are not intended to indicate the order and relative importance thereof. The technical term “connect” (or “engage”) means the realization of connection (or engagement) in a direct or an indirect manner.

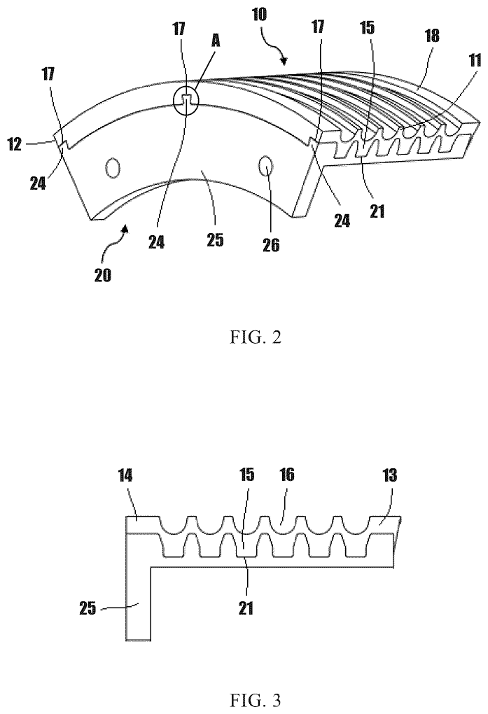

Referring to FIGS. 2 to 6, an embodiment of an elevator sheave liner according to the present disclosure is illustrated in detail in an exemplary manner through these drawings. The elevator sheave liner 10 may be configured to have two, three, or more combinable segments 18 according to application needs. For example, in FIG. 2, one of the combinable segments is illustratively shown. These segments can be arranged in a combinable manner along the circumferential direction of the sheave on the elevator sheave 20, thus forming the elevator sheave liner 10 for engagement with the elevator tension member 107, so that the tension member 107, when driven by the power transmitted from the machine 111 through the elevator sheave 20, can drive the elevator car 103 to move along the guide rail 109 to reach the target landing.

The combinable segment 18 can generally be made of one or more suitable materials such as rubber, which typically have good wear resistance. The bottom of one or more combinable segments 18 in the elevator sheave liner 10 may be provided with a concave-convex structure 17 along the transverse direction (i.e., the width direction of the combinable segment shown in FIG. 2, etc.), where the concave-convex structure 17 matches a concave-convex structure 24 correspondingly arranged on the outer circumferential surface of the elevator sheave 20 along the transverse direction. As an exemplary illustration, FIG. 2 only shows one segment of the elevator sheave 20. In this way, when installing the elevator sheave liner 10, the combinable segment 18 can be stably arranged on the elevator sheave 20 by matching and engaging the above concave-convex structure 17 with the concave-convex structure 24.

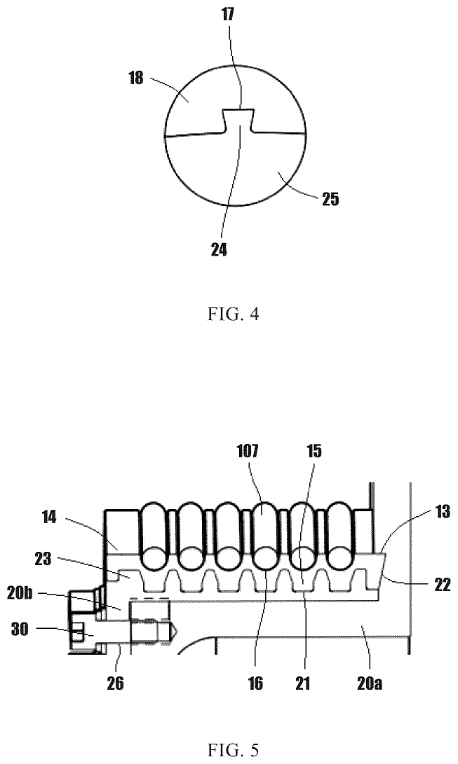

According to the present disclosure, no restrictions are made with respect to the specific structure, arrangement position, number of configuration, etc. of the concave-convex structure 17 and the concave-convex structure 24. As used herein, in various embodiments, the concave-convex structure 17 and the concave-convex structure 24 can be respectively constructed as mutually matching concave part and convex portion arranged in the transverse direction, as shown in FIGS. 2 and 4. Of course, in another or some embodiments, it is also feasible to construct the concave-convex structure 17 or the concave-convex structure 24 to have one or more concave parts and one or more convex portions simultaneously, as long as they can be matched and engaged correspondingly during installation. In addition, as an example, one or more concave-convex structures 17 can be arranged at any suitable position (such as a central position) between the end 11 and end 12 of the combinable segment 18, or a portion of the concave-convex structure 17 (such as half or one-third of the concave part, etc.) can be arranged at the end 11 or end 12, and another portion of the concave-convex structure 17 (such as the other half or two-thirds of the concave part, etc.) can be arranged at the corresponding end of another combinable segment 18 adjacent to the combinable segment 18. The above situation has been schematically shown in FIG. 2.

With continued reference to FIGS. 2, 5 and other drawings, the combinable segment 18 can be constructed with one or more convex portions 15 to be correspondingly assembled to the grooves 21 arranged along the circumferential direction on the elevator sheave 20. In addition, the end portion 13 on one side facing the inner side of the elevator sheave 20 of the combinable segment 18 can be configured to abut against an assembly portion 22 on the elevator sheave 20 during installation so as to be installed in place. For the assembly portion 22, it may be optionally configured to have a concave structure to abut and accommodate the aforementioned end portion 13 of the combinable segment 18. Furthermore, the inner wall of the assembly portion 22 may be optionally configured to have an inclined angle to better fit and abut with the corresponding part of the end portion 13, so that the combinable segment 18 can be fixed in place on the elevator sheave 20 in a more stable and reliable manner. The end portion 14 on one side facing the outer side of the elevator sheave 20 of the combinable segment 18 can be configured to engage an assembly portion 23 on the elevator sheave 20 during installation. For example, the assembly portion 23 may be arranged at the outer end position of the elevator sheave 20 and optionally configured with a convex structure, and a correspondingly matching concave structure arranged on the end portion 14 of the combinable segment 18 is fitted and connected with the aforementioned convex structure. In addition, optionally, the end portion 14 can also be constructed to extend outward along the radial direction of the elevator sheave 20 to exceed the groove 21. This allows for the convex portion 15 of the combinable segment 18 to detach from the corresponding groove 21 by applying a force to the end portion 14 of the combinable segment 18 when needed, therefore making it very convenient and time-and labor-saving to remove the combinable segment 18 from the elevator sheave 20.

By adopting the above arrangement according to the present disclosure, the combinable segment 18 can not only form a reliable engagement between the convex portion 15 arranged along the circumferential direction and the groove 21 of the elevator sheave liner 10, but also form a reliable engagement between the concave-convex structure 17 arranged in the transverse direction and the concave-convex structure 24 of the elevator sheave liner 10. This can significantly enhance the engagement performance between the elevator sheave liner 10 and the elevator sheave 20, effectively prevent the sliding, loosening or falling off of the elevator sheave liner relative to the elevator sheave during use, and thus significantly improve the safety performance of the elevator system.

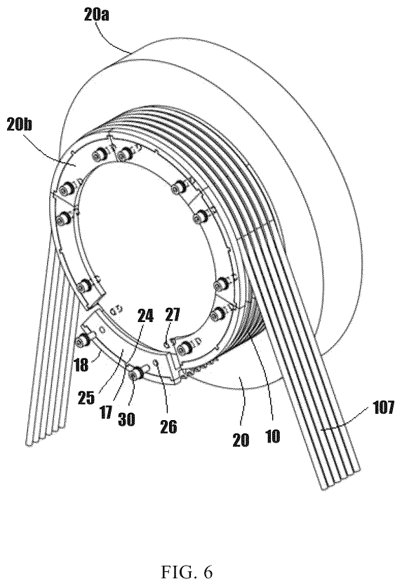

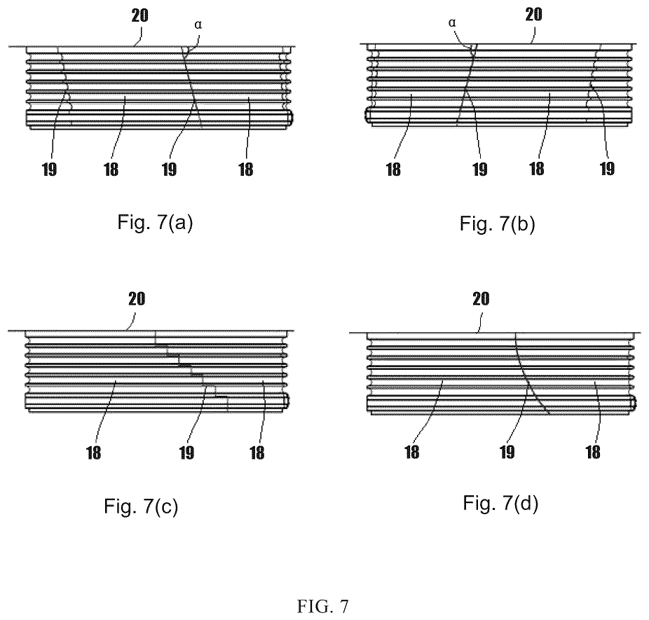

Referring to the embodiments shown in FIGS. 6 and 7, the elevator sheave liner 10 configured with six combinable segments 18 is shown in an exemplary manner. It should be noted that these segments may have the same or different structural configurations in terms of circumferential length, edge contour, material, and color selection. For example, the seam 19 of two assembled adjacent segments 18 of the elevator sheave liner 10 can be configured into any suitable shape as needed. For example, in FIGS. 7(a)-7(d), seam configurations such as oblique line shape, stepped shape (FIG. 7(c)), and arc shape (FIG. 7(d)) are shown respectively. FIGS. 7(a) and 7(b) also show that such oblique lines can have different tilt directions relative to the axis of the elevator sheave 20. For example, optionally, the oblique line can be configured to form an angle α relative to the longitudinal section of the elevator sheave 20, where the angle a is greater than or equal to 10° and less than 90°. In the case where the seam 19 between two adjacent combinable segments 18 has a seam configuration that is not parallel to the axis of the elevator sheave 20, this will result in a contact time difference between the elevator tension member 107 and different seam parts, thereby effectively reducing or avoiding adverse effects such as vibration and noise that may be caused by the elevator tension member 107 when coming into contact with the seam 19.

It should be appreciated that the present disclosure allows for flexible configuration according to actual application requirements in terms of the specific number of blocks configured for the elevator sheave liner 10, the configuration settings of the respective blocks, and the matching settings between the respective blocks, where no restrictions are made in this regard.

In one or some embodiments, an assembly portion may be provided on the combinable segment 18 to match and install an additionally configured fastening member (not shown). Through the installed fastening member, a force can be applied along the radial direction of the elevator sheave 20, so that the assembled elevator sheave liner 10 can be more reliably fastened to the elevator sheave 20. The aforementioned assembly portion of the combinable segment 18 can be implemented in various feasible forms. For example, a groove can be arranged on the top of the end portion 14 on one side facing the outer side of the elevator sheave 20 of the combinable segment 18, and a fastening member that can be configured into a circular shape is placed in the groove. And then, the two ends of the fastening member are tightened together by fasteners such as screws or bolts, so that the elevator sheave liner 10 and elevator sheave 20 can be assembled more firmly together by applying force to them through the fastening members.

In addition, in one or some embodiments, an adhesive can also be used to bond the elevator sheave liner 10 and elevator sheave 20 together, which is conducive to further forming a stronger and more reliable connection between them. The specific position to coat the adhesive and the type of the adhesive used may be selected and configured as needed.

According to the solutions of the present disclosure, an elevator sheave assembly is also provided, which is configured with an elevator sheave and an elevator sheave liner according to the present disclosure that is correspondingly arranged on the elevator sheave. As the elevator sheave liner has the obvious advantages of, for example, stable working performance, high reliability, easy processing and manufacturing, easy assembly and maintenance, and low application cost, through a plurality of connection methods, as mentioned earlier, the elevator sheave assembly is applicable to a wide range of elevator systems. This helps to ensure the stable operation of the elevator system and improve system safety performance.

Referring to FIG. 5 and other figures, as used herein, in various embodiments, the elevator sheave 20 can be optionally configured to have two parts, namely a body 20a and a bracket 20b. The bracket 20b can usually be made of metal materials. For example, it can use the same or different metal materials as the body 20a, such as using metal materials with more wear-resistant properties than the body 20a. The bracket 20b may be integrally formed and detachably mounted on the body 20a, or the bracket 20b may be configured to have two, three, or more assemblable bracket segments 25 as needed. These assemblable bracket segments 25 can be arranged in a combinable manner on the body 20a to form an elevator sheave 20. In addition, in one or some embodiments, the aforementioned concave-convex structure 24 and groove 21 may be simultaneously arranged on all the assemblable bracket segments 25, or only selected to be arranged on a portion of the assemblable bracket segments 25, so as to engage the corresponding matching structures on the elevator sheave liner 10 according to specific application needs.

In addition, optionally, the number of assemblable bracket segments 25 may be configured to be exactly the same as the number of combinable segments 18, so that each pair of assemblable bracket segment 25 and combinable segment 18 can be independently made into a composite unit, for example, through assembly operations or molding processes. And then, by using the fasteners 30 such as screws or bolts, and through the assembly portions 26 (such as mounting holes) provided on the assemblable bracket segment 25 and the assembly portions 27 (such as mounting holes) provided on the body 20a, the composite unit can be secured to the body 20a. The entire installation process is very convenient and is also beneficial for future maintenance and replacement operations.

The assemblable bracket segment 25 is less prone to wear compared to combinable segment 18 and can be reused. In practical applications, in the case where one or more combinable segments 18 in an elevator sheave liner 10 are completely worn out, and even in extreme cases where all combinable segments 18 in the entire elevator sheave liner 10 are completely worn out, due to the presence of combinable bracket segments 25, they can still meet the traction force requirements of the elevator tension member 107 without affecting the normal operation of the system. Therefore, staff can be arranged at an appropriate time (i.e., during normal idle hours of elevator operation, such as non-working days or nights) to replace and install new combinable segments 18, which is very conducive to reducing system downtime, lowering overall service costs, and prolonging the service life of elevator tension members and other components, and reducing impact on the environment, thus promoting and enhancing the safety performance and market competitiveness of the elevator system.

An elevator sheave liner, an elevator sheave assembly, and an elevator system according to the present disclosure have been described above in detail by way of examples only. These examples are merely used to illustrate the principles and embodiments of the present disclosure, rather than limiting the present disclosure. Various modifications and improvements can be made by those skilled in the art without departing from the spirit and scope of the present disclosure. Therefore, all equivalent technical solutions should fall within the scope of the present disclosure and be defined by the claims of the present disclosure.

What is claimed is:

1. An elevator sheave liner, comprising two or more combinable segments arranged on an elevator sheave in a combinable manner to form an elevator sheave liner for engagement with an elevator tension member, wherein at least one of the combinable segments is provided with a first concave-convex structure along a transverse direction on a bottom of the at least one of the combinable segments, the first concave-convex structure matching a second concave-convex structure arranged transversely on an outer circumferential surface of the elevator sheave to engage correspondingly with each other when the at least one combinable segment is arranged on the elevator sheave.

2. The elevator sheave liner according to claim 1, wherein the combinable segment has a first end and a second end opposite to each other along a circumferential direction of the elevator sheave, the first concave-convex structure is arranged at a position between the first end and the second end, and/or a portion of the first concave-convex structure is arranged at the first end or the second end, and the other portion of the first concave-convex structure is arranged at a corresponding end of another combinable segment adjacent to the combinable segment.

3. The elevator sheave liner according to claim 1, wherein the first concave-convex structure comprises at least one groove arranged along an axial direction of the elevator sheave, and the second concave-convex structure comprises at least one convex portion arranged along the axial direction of the elevator sheave.

4. The elevator sheave liner according to claim 1, wherein the combinable segment is configured with:
a first side end and a second side end opposite to each other along the axial direction of the elevator sheave, wherein the first side end is configured to be mounted in place against a first assembly portion on the elevator sheave during installation, and the second side end is configured to be engaged with a second assembly portion on the elevator sheave during installation; and
a convex portion arranged between the first side end and the second side end and configured for installation in a groove arranged along the circumferential direction on the elevator sheave.

5. The elevator sheave liner according to claim 4, wherein the second assembly portion is provided at an outer end of the elevator sheave, and the second side end is configured to extend outwardly along a radial direction of the elevator sheave and exceed the groove after installation, for disassembling the combinable segment from the elevator sheave by applying a force to the second side end to cause the combinable segment to disengage from the groove.

6. The elevator sheave liner according to claim 1, wherein a seam between two adjacent combinable segments of the elevator sheave liner is configured in a shape of a step, an arc, or an oblique line forming an angle of less than 90° and not less than 10° with a longitudinal section of the elevator sheave.

7. The elevator sheave liner according to claim 1, wherein an assembly portion is provided on the combinable segment for securing the elevator sheave liner formed after combination in place on the elevator sheave by installing a fastening member in the assembly portion and providing a force along the radial direction of the elevator sheave.

8. An elevator sheave assembly, comprising:
an elevator sheave liner according to claim 1; and
an elevator sheave having a second concave-convex structure arranged on an outer circumferential surface thereof, wherein the second concave-convex structure is engaged correspondingly with the first concave-convex structure of the elevator sheave liner when the elevator sheave liner is arranged on the elevator sheave.

9. The elevator sheave assembly according to claim 8, wherein the elevator sheave comprises a body, and a bracket detachably arranged on the body and engaged with the elevator sheave liner.

10. The elevator sheave assembly according to claim 9, wherein the bracket has two or more assemblable bracket segments arranged on the body in a combinable manner.

11. The elevator sheave assembly according to claim 10, wherein each assemblable bracket segment has a first portion and a second portion, the first portion is provided with a groove for engagement with a convex portion on the combinable segment, and the second portion is connected to the first portion and extends along a radial direction of the elevator sheave towards a center direction of the elevator sheave.

12. The elevator sheave assembly according to claim 11, wherein the number of the assemblable bracket segments configured is the same as the number of the combinable segments configured, and each pair of assemblable bracket segment and combinable segment, after being separately arranged in a combinable manner, are secured to the body through a mounting member.

13. The elevator sheave assembly according to claim 8, wherein the elevator sheave liner is further connected to the elevator sheave through an adhesive.

14. An elevator system, comprising:
a power device configured to provide power;
an elevator car configured to run between elevator landings when driven by the power; and
an elevator tension member, and an elevator sheave assembly according to claim 8, wherein the elevator sheave is connected to a power output end of the power device, and the elevator tension member is engaged with the elevator sheave liner and connected to the elevator car to transmit the power to the elevator car.

15. The elevator system according to claim 14, wherein the power device includes a traction machine and a winch, and/or the elevator tension member includes a steel belt and a rope.
